(19) United States
(12) Patent Application Publication
(10) Pub. No.: US 2026/0337875 A1
(43) Pub. Date: Oct. 29, 2026

(54) AQUEOUS COMPOSITION, ITS USE AND METHOD FOR PROVIDING AT LEAST ONE BARRIER PROPERTY

(71) Applicant: Kemira Oyj, Helsinki (FI)

(72) Inventors: Markus KVIST, Espoo (FI); Sami PUTTONEN, Helsinki (FI); Leif ROBERTSEN, Espoo (FI); Tarja TURKKI, Espoo (FI); Jonas KONN, Espoo (FI); Jaana LAINE, Espoo (FI)

(21) Appl. No.: 19/120,503

(22) PCT Filed: Oct. 12, 2023
(86) PCT No.: PCT/FI2023/050584

§ 371 Date: Apr. 11, 2025

(30) Foreign Application Priority Data
Oct. 13, 2022 (FI) 20225925

(51) Int. Cl. D06M 15/03; D06M 13/228; D06M 101/06

(52) U.S. Cl. CPC D06M 15/03; D06M 13/228; D06M 2101/06; D06M 2200/11; D06M 2200/12; D10B 2201/00

(57) ABSTRACT

The invention relates to an aqueous composition for providing at least one barrier property, such as grease, oil and/or water barrier property, for a product comprising cellulosic fibres, and to the use of the composition. The composition comprises α-(1,3→glucan) polymer and at least 0.1 weight-% of alkyl ketene dimer, calculated from dry solids weight of the composition.

The present invention relates to an aqueous composition, its use and to a method for providing at least one barrier property according to the preambles of enclosed independent claims.

There is a growing trend to decrease the use of plastics used as packaging material for various goods. A natural alternative for plastics is cellulose fibre-based products, such as paper and board. Paper and board are inherently two-dimensional, sheet-like products that can be folded into three-dimensional packages. It is also possible to manufacture three-dimensional packages by using cellulose fibres by using moulded fibre technology. The packaging materials based on cellulose fibres generally provide strength properties that are appropriate for protecting the packaged goods.

However, in certain applications the packaging material should also have barrier properties in order to prevent the transfer of moisture, liquids, oil, grease and/or gas through the packaging material. The packaging material should have adequate barrier properties to prevent the interaction of the packaged goods and the surrounding environment through the packaging material. The problem is that packaging materials based on cellulose fibres do not necessarily have required barrier properties, especially for food packaging purposes.

Barrier properties of materials based on cellulose fibres can be improved either by internal sizing or by various surface treatments. Internal sizing alone does not necessarily provide required moisture, liquid, grease and oil barrier properties. A conventional solution, which is to laminate a plastic film on the surface of the material based on cellulose fibres, is not completely unproblematic. The laminated plastic films may cause problems in recycling of the packaging material, e.g. in repulping and composting. Furthermore, film laminating techniques are not suitable for providing barrier properties for three-dimensional moulded fibre articles.

In view of above, there is a constant need to improve barrier properties of packaging materials based on cellulose fibres. Especially there is a need for compositions that provide barrier properties and that can be applied both of two- and three-dimensional articles. Preferably, the compositions used for providing barrier properties are also bio-based, biodegradable and recyclable in order to reduce the use of petroleum-based components, bioaccumulation and carbon footprint in packaging industry.

An object of the present invention is to minimise or even eliminate the disadvantages existing in the prior art.

An object of the present invention is also to provide an aqueous composition which provides at least one barrier property, preferably at least two barrier properties, for products comprising cellulosic fibres and which is easy to apply even on three-dimensional articles.

These objects are attained with the invention having the characteristics presented below in the characterising parts of the independent claims. Some preferred embodiments of the invention are presented in the dependent claims. The features recited in the dependent claims are freely combinable with each other unless otherwise explicitly stated.

A typical aqueous composition according to the present invention for providing at least one barrier property, such as grease, oil, fat, water, gas and/or mineral oil barrier property, for a product comprising cellulosic fibres, comprises an α-(1,3→glucan) polymer and at least 0.1 weight-% of alkyl ketene dimer, calculated from dry solids weight of the composition.

A typical use according to the present invention of the inventive aqueous composition is for providing at least one barrier property, such as grease, oil, fat, water, gas and/or mineral oil barrier property, for a product comprising cellulosic fibres by applying the aqueous composition on a surface of the product.

A typical method for providing at least one barrier property, such as grease, oil, fat, water, gas and/or mineral oil barrier property, for a cellulosic product comprising cellulosic fibres, comprises
forming the cellulosic product,
drying the cellulosic product,
applying an aqueous composition according to the invention on at least one surface of the product.

Now it has been surprisingly found that an aqueous composition comprising both an α-(1,3→glucan) polymer and alkyl ketene dimer is easy to apply to the surface of a product comprising cellulosic fibres by using conventional surface applying techniques. Furthermore, the composition comprising α-(1,3→glucan) polymer and alkyl ketene dimer, prepared by mixing, provides also surprisingly good barrier properties for the product. The obtained barrier property may comprise at least one, possibly and preferably more, barrier property(-ies) selected from grease, oil, fat, water, gas and mineral oil barrier properties. In comparison to other possible polysaccharide polymers, such as starch or carboxymethyl cellulose, α-(1,3→glucan) polymer provides acceptable or good barrier properties for the surface-treated product. This means that the amount of bio-based and biodegradable components can be increased in the manufacture of cellulosic products, especially in manufacture of cellulosic packaging materials, without serious compromises in the quality of the final product. It is speculated that the recyclability of the surface-treated products may become easier, allowing repulping by using conventional repulping techniques. At least, the components of the aqueous composition are readily biodegradable, which may provide additional and/or new alternatives, when end-of-life options for the surface-treated products are considered.

The present invention may provide the product comprising cellulosic fibres with at least two barrier properties selected from grease, oil, fat, water, gas and mineral oil barrier properties. Often, especially in food contact applications, it is important that the product comprising cellulosic fibres shows acceptable grease, oil and water barrier properties. Earlier, this may have required use of multiple different barrier compositions. The present invention now provides an aqueous composition, which can be used alone to provide the product with multiple barrier properties. According to one embodiment, the aqueous composition may provide the product comprising cellulosic fibres with good or at least acceptable grease and oil barrier properties in combination with good or at least acceptable water barrier properties.

The aqueous composition may be a coating composition or surface sizing composition, or it may form a part of a coating composition or surface size composition, for a cellulosic fibrous web, such as paper, board or the like or for a cellulosic product, such as moulded fibre product.

The aqueous composition may comprise 65-99.9 weight-%, preferably 70-99 weight-%, more preferably 75-95 weight-%, of α-(1,3→glucan) polymer, calculated from dry solids weight of the composition. For example, the aqueous composition may comprise 60-99.9 weight-%, preferably 65-90 weight-%, more preferably 70-85 weight-%, of α-(1,3→glucan) polymer, calculated from dry solids weight of the composition. According to one preferable embodiment, the aqueous composition may comprise 60-93 weight-%, preferably 65-89 weight-%, more preferably 70-87 weight-%, of α-(1,3→glucan) polymer, calculated from dry solids weight of the composition. It is highly surprising that the aqueous composition may comprise such a high amounts of α-(1,3→glucan) polymer while providing appropriate barrier properties for the final product. This means that the amount of non-biobased component can be minimized in the formed barrier layer, thus making the final product environmentally more sustainable.

In the present context the “α-(1,3→glucan) polymer” denotes a polymer having a polysaccharide backbone which comprises D-glucose units linked together by glycosidic linkages. At least 70%, preferably at least 80%, more preferably at least 90% or 95%, sometimes even of 99% or 100%, of the glucosidic linkages are α-1,3-linkages. This means that in the polysaccharide backbone the α-D-glucose units are connected to each other through carbons 1 and 3 on adjacent α-D-glucose rings. The form of glycosidic linkages can be determined by a person skilled in the art by using methods known as such, for example ¹HNMR.

According to one embodiment of the invention the α-(1,3→glucan) polymer may have a degree of polymerization in a range of 55-10 000, preferably 55-5000, more preferably 100-1000.

The polysaccharide backbone of the α-(1,3→glucan) polymer may be linear, i.e. it may be unbranched.

The polysaccharide backbone of α-(1,3→glucan) polymer may be substituted, i.e. the α-(1,3→glucan) polymer may comprise substitution groups substituted to the hydroxyl groups of the polysaccharide backbone. According to one embodiment of the invention the α-(1,3→glucan) polymer may have a substitution degree in a range of 0.05-3, preferably 0.1-2.0, preferably 0.2-1.5, more preferably 0.2-1 or 0.2-0.8. The substitution degree may be, for example, 0.3-0.7 or 0.3-0.6. The substitution degree refers to the average number of hydroxyl groups substituted in each D-glucose unit in the polysaccharide backbone of α-(1,3→glucan) polymer with substitution groups. Since there are three hydroxyl groups in each D-glucose unit, the substitution degree can be no higher than 3.

According to one preferable embodiment, α-(1,3→glucan) polymer may be poly hydroxyalkyl α-(1,3→glucan), such as poly hydroxyethyl α-(1,3→glucan).

The aqueous coating composition may comprise anionic or cationic α-(1,3→glucan) polymer. Anionicity or cationicity of the α-(1,3→glucan) polymer may have a positive impact on its water-solubility.

According to one embodiment of the invention, the used α-(1,3→glucan) polymer may be anionic, i.e. its structure contains anionic groups, e.g. carboxylic groups.

30 According to one preferable embodiment the α-(1,3→glucan) polymer is cationic, i.e. it comprises cationic substitution groups. The cationic substitution group may be a substituted ammonium group, preferably a quaternary ammonium group, more preferably a trialkyl ammonium group. Alkyl group in the trialkyl ammonium group may be, for example a methyl group, a hydroxymethyl group, a hydroxyethyl group or a hydroxypropyl group. The substituted ammonium group may be, for example, trimethylammonium group. Cationic substitution groups improve the water solubility of the α-(1,3→glucan) polymer.

According to one preferable embodiment the α-(1,3→glucan) polymer is water-soluble. This means that the α-(1,3→glucan) polymer is soluble in water at 1 weight-% concentration, at pH 7, at 25 °C. After dissolution, no solid particles can be visually observed, and the obtained solution is completely transparent. The water-solubility provides even and good coverage for the obtained barrier layer, formed by application of the aqueous composition.

The aqueous composition according to the present invention comprises further at least 0.1 weight-% of alkyl ketene dimer, calculated from dry solids weight of the composition. According to one preferable embodiment of the invention the composition may comprise 0.1-35 weight-%, preferably 1-30 weight-%, more preferably 5-25 weight-%, of alkyl ketene dimer, calculated from dry solids weight of the composition. The composition may comprise 0.1-40 weight-%, preferably 10-35 weight-%, more preferably 15-30 weight-%, of alkyl ketene dimer, calculated from dry solids weight of the composition. According to one preferable embodiment, the aqueous composition may comprise 7-40 weight-%, preferably 11-35 weight-%, more preferably 13-30 weight-%, of alkyl ketene dimer, calculated from dry solids weight of the composition. Alkyl ketene dimer is able to enhance the water barrier properties provided by the aqueous composition while the obtainable grease and oil barrier properties are maintained at least on an acceptable level. The presence of alkyl ketene dimer, even when present in the aqueous composition in relatively small amounts, thus improves the general barrier properties, as described above, and may provide the product comprising cellulosic fibres more than one improved barrier property.

The alkyl ketene dimer may be C14-C22 alkyl ketene dimer, preferably C16-C18 alkyl ketene dimer, or their mixture. The alkyl ketene dimer may be in form of polysaccharide stabilized aqueous dispersion when it is mixed with the α-(1,3→glucan) polymer to form the aqueous composition.

The alkyl ketene dimer may have a charge density in the range from −100 μmeq/g to +600 μmeq/g, at pH 3.5. According to one embodiment the alkyl ketene dimer is cationic. The cationic alkyl ketene dimer may have a charge density in the range from +25 μmeq/g to +600 μmeq/g, preferably from +50 μmeq/g to +250 μmeq/g, more preferably from +75 to +150 μmeq/g, at pH 3.5. According to another embodiment the alkyl ketene dimer may be anionic. The cationic alkyl ketene dimer may have a charge density in the range from −100 μmeq/g to <0 μmeq/g, preferably from −75 μmeq/g to −0.1 μmeq/g, more preferably from −25 to −5 μmeq/g, at pH 3.5.

Preferably, alkyl ketene dimer and α-(1,3→glucan) polymer have the same ionicity, i.e. they are both either anionic or cationic. According to one preferable embodiment, both α-(1,3→glucan) polymer and alkyl ketene dimer are cationic. According to another preferable embodiment, both α-(1,3→glucan) polymer and alkyl ketene dimer are anionic. According to a further embodiment, the alkyl ketene dimer and α-(1,3→glucan) polymer have the different ionicity.

The aqueous composition according to the present invention is prepared by mixing the α-(1,3→glucan) polymer and alkyl ketene dimer together. It is anticipated that no chemical reactions occur between α-(1,3→glucan) polymer and alkyl ketene dimer and alkyl ketene dimer This means that the aqueous composition is free of covalent bonds between the α-(1,3→glucan) polymer and alkyl ketene dimer. The aqueous composition is easy to produce by mixing with conventional mixing equipment and it still provides good barrier properties when applied on the surface of a fibrous product comprising cellulosic fibres.

In addition to α-(1,3→glucan) polymer and alkyl ketene dimer the aqueous composition may comprise one or more additive agents. The amount of additive agents may be 0.25-20 parts, preferably 0.5-15 parts, more preferably 1-10 parts, more preferably 2-5 parts, calculated relative to total amount of alkyl ketene and α-(1,3→glucan) polymer, which have been associated with the value of 100.

The one or more additive agents may be selected from inorganic particles, such as kaolin, calcium carbonates, talc, titanium dioxide and any of their mixtures; defoamers, such as silica-based defoamers; rheology modifiers, such as acrylates, acrylic copolymers and/or hydrophobically modified ethoxylated urethanes; wetting agents, such as surfactants; other barrier promoting polymers, and/or heat sealable polymers, such as styrene acrylates. The aqueous composition is preferably free of organic solvents.

According to one embodiment, the aqueous composition consists of α-(1,3→glucan) polymer and alkyl ketene dimer, and optionally inorganic particles as defined above.

The aqueous composition may be applied on the surface of a product comprising cellulosic fibres by using any conventional coating and/or surface sizing method, such as rod coating, curtain coating, size press coating or spray coating. The aqueous composition may have a solids content in a range of 2.5-50 weight-%, preferably 5-35 weight-%, more preferably 10-25 weight-%. The aqueous composition may have a viscosity in a range of 50-2000 mPas, preferably 50-1000 mPas, measured with Brookfield DV-E, at 23 °C, 100 rpm. This means that the composition is easy to apply on the surface of a product comprising cellulosic fibres by using conventional applying methods, such as surface sizing, air knife coating, rod coating, bar coating, blade coating, gravure coating, roll coating, curtain coating, size press coating or spray coating. In some embodiments, the aqueous composition may be heated before application in order to decrease the viscosity. The aqueous composition may be applied, for example, at an application temperature of 15-50 °C, typically 20-40 °C.

The aqueous composition according to the invention is applied on the surface of a product comprising cellulosic fibres. The cellulosic fibres may be virgin fibres or recycled fibres, or a mixture of virgin fibres and recycled fibres. The cellulosic fibres may have been obtained by any available pulping method, such as by mechanical pulping, chemical pulping, thermomechanical pulping or chemi-thermomechanical pulping. The cellulosic fibres may comprise any cellulosic fibres separated e.g. from wood (softwood, hardwood or their combinations). The cellulosic fibres may be bleached, unbleached, or a combination thereof.

In addition to cellulosic fibres the product may comprise inorganic filler particles, such as particles of calcium carbonate, kaolin, talc, titanium dioxide, or any of their combinations.

Preferably the aqueous composition is applied directly on the surface of the product comprising cellulosic fibres, i.e. without any intermediate layers. The aqueous composition may be applied on the surface of the product before and/or after drying of the product. This means that the application may be done on a wet surface, for example by spraying, and/or on the dry surface e.g. by using any conventional coating technique, such as spray coating, rod coating or size press coating.

According to one preferable embodiment the aqueous composition according to the present invention is applied by spraying on the surface of a three-dimensional product comprising cellulosic fibres, for example, on the surface of a moulded fibre product. The moulded fibre product may be a bowl, container, tray, plate or the like. According to one embodiment the moulded product comprising cellulosic fibres may be ready-to-eat meal packaging unit, egg container, meat container, cup, sip lid, or a food carrying product, such as tray or plate. By applying the aqueous composition by spraying, it is possible to effectively cover even the cavities, compartments, recesses and the like of the three-dimensional product.

According to one embodiment, the aqueous composition may be applied on the surface of a first product comprising cellulose fibres or cellulosic fibres, after which and before drying of the applied composition, at least one second product is attached to the surface of the first product by using the applied aqueous composition as an adhesive between the first and second product. The obtained final product thus comprises a first layer which consists of the first product and at least one second layer which consists of the second product and an intermediate adhesive layer formed by the applied aqueous composition. Optionally, additional second products are attached to further enhance the properties and characteristics of the product, whereby the aqueous composition is applied as an adhesive between the additional second products. The first and the second product(s) can be in form of sheets or webs having two parallel large surfaces, wherein the aqueous composition is applied on at least one of the large surfaces of the first product and the one of the large surfaces of the second product is attached to it. Alternatively, the first and the second product(s) may have three-dimensional forms that can be arranged to fit snugly inside one another, and the aqueous composition is sprayed on the surface of the first product, whereafter the second product is suitably fitted to the first product for attachment.

The aqueous composition may be applied in amount that provides a uniform barrier layer on the surface of the product or in amount that provides appropriate adhesion between the first product and the second product(s). The aqueous composition may be applied as two or more layers on the surface of the product. In this manner the amount of aqueous composition in each layer may be lower, and/or it is possible to obtain a barrier layer which has low number of pin holes, if any. The applied layers are identical for their chemical composition, but application amount, i.e. layer weight may be different. In one embodiment all applied layers identical with each other. The aqueous composition may be added in a total amount of at least 1.5 g/m², preferably 1.5-15 g/m², more preferably 2-10 g/m².

According to one embodiment of the invention, the aqueous composition is applied to cover a part of the surface of the product. For example, the aqueous composition may be applied on an interior or exterior surface of a three-dimensional product, for example by spraying.

If the product comprising cellulose fibres is coated with two or more successive layers of the aqueous composition, the successive layers after the first layer may be applied with or without intermediate drying, i.e. either as wet-on-dry or wet-on-wet application. According to one embodiment, the surface of the product is dried between the application of two or more successive layers.

The aqueous composition according to the present invention provides at least one barrier property, such as grease, oil and/or water barrier property, for a product comprising cellulosic fibres. Preferably the aqueous composition provides simultaneously at least two barrier properties, especially simultaneous grease and water barrier properties. It has been surprisingly found that the aqueous composition provides greatly increased oil penetration time for the product comprising cellulosic fibres.

According to one preferable embodiment, the application of the aqueous composition provides the product with TAPPI 559 KIT test value of at least 4, preferably at least 8, more preferably at least 12. The KIT test value measures the repellency of the coating to oil and grease and the measurements are performed according to standard TAPPI method T-559.

### EXPERIMENTAL

### Example 1

### Preparation of Two-Dimensional Sheets

A fibre stock with 0.1-0.6 weight-% consistency was made from 100% birch kraft pale pulp was prepared. 0.02-0.06 weight-% of alkyl ketene dimer AKD, as dry, was added to the fibre stock, and the fibre stock is mixed for at least 2 minutes under turbulent conditions, followed by addition of 0.04-0.08 weight-%, as dry, of a mixture of synthetic retention polymers polydiallyldimethylammonium chloride and cationic polyacrylamide (PDACMAC+CPAM). The used retention polymers were high to very high average molecular weight MW (at least 2 000 000 Da) and they had low to medium charge density (5-20 mol-% from cationic monomers). After addition of PDADMAC+CPAM the stock is mixed at least 1 minute before vacuum forming the fiber stock to dryness of 20-30 weight-% by using Dynamic Drainage Analyzer (Pulpeye AB, Sweden), under 200-650 mBar vacuum against planar round forming wire with 200-400 μm openings, 10 cm. The wet sheets with grammage of 200-800 g/m² (as dry) are pressed between blotting papers using L&W sheet press until dryness of 25-55% is reached. The sheets are then hot press dried and thermoformed to 0.2-1.2 mm thickness between 130-200 °C. metal plates until dryness of 94-99% is reached. The obtained final sheets had a Bendtsen roughness of 300-700 ml/min, measured according to ISO 8791-2 and a Bendtsen air permeability of 20-25 ml/min, measured according to ISO 5636-3.

### Preparation of the Aqueous Composition

Dry cationic α-(1,3→glucan) polymer (degree of polymerisation 450; degree of substitution 0.3) was dissolved in deionized water to obtain a polymer solution with concentration of 3.4 weight-%, as dry. Commercial cationic alkyl ketene dimer, comprising 95 weight-%, as dry, of C18-alkyl ketene dimer, was obtained as 20 weight-% solution, as dry weight. Alkyl ketene dimer solution was added to α-(1,3→glucan) polymer solution until obtained aqueous composition had alkyl ketene dimer concentration of 27.6 weight-%, calculated from dry solid content of the aqueous composition. The aqueous composition comprising α-(1,3→glucan) polymer and alkyl ketene dimer was mixed until both components were visually dispersed.

Spray Coating of Two-Dimensional Sheets with the Aqueous Composition

The prepared two-dimensional sheets were spray coated with the prepared aqueous composition by allowing each sheet to pass a spray beam as many times as was needed to reach 7.9-8.4 g/m² coat weight, as dry. The coated sheets were dried in oven at 105 °C for 15 minutes. The dried sheets were conditioned at RH 50% at 23 °C and their barrier performance were measured according to ISO 535:2014 (Cobb60), Tappi T559 cm-02 (KIT) and ASTM F119-82:2015 (oil penetration time).

Reference sample R-1 was spray coated with solution of cationic alkyl ketene dimer, concentration 20 weight-%, and Reference samples R-2, R-3 with solution of cationic α-(1,3→glucan) polymer, concentration 3.6 weight-%. Cationic alkyl ketene dimer and cationic α-(1,3→glucan) polymer were those used for aqueous composition.

The results are shown in Table 1.

TABLE 1
Results of Example 1.

| | | Coat | | Olive oil | |
|---|---|---|---|---|---|
| | Sprayed | weight | KIT- | penetration | Cobb60 |
| Sample | Chemical | [g/m²] | value | time [h] | [g/m²] |
| R-1 | Cationic AKD | 16.6 | 5 | <0.1 | 10 |
| (ref.) | | | | | |
| R-2 | Cationic α- | 4.5 | 10 | 11 | 46 |
| (ref.) | (1,3→glucan) | | | | |
| | polymer | | | | |
| R-3 | Cationic α- | 12.8 | 9 | 14 | 46 |
| (ref.) | (1,3→glucan) | | | | |
| | polymer | | | | |
| C-I | Aqueous | 7.9 | 8 | 9 | 31 |
| | Composition | | | | |

It can be seen from the results in Table 1 that the aqueous composition according to the present invention provides the coated sheet with both appropriate water barrier performance (Cobb60) as well as good grease and oil barrier properties.

### Example 2

The chemicals used in Example 2 are listed in Table 2. The chemicals were used as obtained commercial solutions (alkyl ketene dimers) or prepared into solution form, either by dissolving in hot water (α-(1,3→glucan) polymers, CMC) or by cooking at 95 °C for 30 minutes (starches).

TABLE 2
Chemicals used in Example 2.

| | | | Solid |
|---|---|---|---|
| | | | content |
| Chemical | Abbreviation | Properties | [w %] |
| Anionic starch | AS | Hypochlorite oxidized potato starch, | 10 |
| | | viscosity 20-30 mPas, at 60 °C | |
| Cationic starch | CS | Oxidized starch, DS 0.018 | 10 |
| Carboxymethyl | CMC | Commercial product, MW ca. 146 000, | 8 |
| cellulose. | | viscosity 20-50 mPas, at 10% solids | |
| Cationic α- | C-alpha | Degree of polymerisation 450, DS 0.3 | 4.4 |
| (1,3→glucan) polymer | | | |
| Anionic α-(1,3→glucan) | A-alpha | Degree of polymerisation 450, DS | 4.4 |
| polymer | | 0.24 | |
| Cationic alkyl ketene | C-AKD | Commercial product, charge density | 24 |
| dimer | | about 75-150 μeq/g, C16:C18 ratio 5- | |
| | | 95% | |
| Anionic alkyl ketene | A-AKD | Commercial product, charge density | 19 |
| dimer | | about from −20 to 0 μeq/g, C16:C18 | |
| | | ratio 35-65% | |

The aqueous compositions were prepared according to Table 3 by mixing the components of the composition in a Diaf mixer.

TABLE 3
Aqueous compositions used in Example 2.

| | | | | | | | | Solids | |
|---|---|---|---|---|---|---|---|---|---|
| | | | C- | A- | | C- | A- | content | |
| | CS | AS | alpha | alpha | CMC | AKD | AKD | [w-%] | pH |
| COMP-1 | 75 | | | | | 25 | | 5.4 | 3.9 |
| (ref.) | | | | | | | | | |
| COMP-2 | | 75 | | | | | 25 | 12.2 | 4.1 |
| (ref.) | | | | | | | | | |
| COMP-3 | | | | | 75 | | 25 | 5.4 | 5.5 |
| (ref.) | | | | | | | | | |
| COMP-4 | | | 75 | | | 25 | | 5.6 | 4.8 |
| COMP-5 | | | 90 | | | 10 | | 4.7 | 7.2 |
| COMP-6 | | | | 75 | | | 25 | 5.2 | 5.8 |
| COMP-7 | | | | 90 | | | 10 | 5.6 | 6.3 |

In coating experiments the used substrate was 205 g/m² folding box board. One or two coating layers were applied on the uncoated substrate by using RK K Control Coater rod coating unit. For single coated samples the coating was applied by using coating rods 1-3. For double-coated samples the coating layers were applied by using coating rods 3-5, and first layer was allowed to rest at room temperature for 15-30 minutes before application of the second layer. Drying of the final single/double coating was carried out using IR dryer for 60 seconds. Aqueous compositions were kept at 40 °C during the coating process.

The coated sheets were climatized for minimum of 18 hours before measuring the coat weight.

Following barrier properties were tested, used standard methods given in parenthesis:
Water vapor, WVTR (ASTM E-96, D3985 & F1927, 23 °C. 50% RH)
Water, Cobb 300s (ISO 535)
Grease and oil
   KIT test (TAPPI method T-559 μm-96)
   Olive oil penetration (ASTM F119-82:2015), 50 °C.

Cobb300 value was measured from 2 parallel samples and the value is reported as average of the two measurements. Olive oil penetration was measured for four parallel samples, and the value is reported as the average of the measurements.

The results of Example 2 are given in Table 4.

It can be seen from Table 4 that the samples Comp-4 to Comp-7, coated with the aqueous composition according to the invention provide better grease and oil barrier properties with acceptable water barrier properties. The difference is significant to the reference samples, which were coated with composition comprising alkyl ketene dimer and other polysaccharide (starch/CMC).

TABLE 4
Results of Example 2.

| | | | | WVTR | | |
|---|---|---|---|---|---|---|
| | | Coat | | 23 °C | Olive oil | Cobb |
| | Coat | weight | | 50% RH | penetration | 300 s |
| | layer | [g/m²] | KIT | [g/m², d] | time [h] | [g/m²] |
| Comp-1 | single | 3.6-4.4 | <1 | — | 0.1 | 46 |
| (ref) | double | 6.3-7.2 | <1 | 148 | 0.2 | 47 |
| Comp-2 | single | 4.3-4.6 | 1 | 173 | 0.1 | 52 |
| (ref) | double | 7.5-7.8 | 5 | 156 | 1.9 | 45 |
| Comp-3 | single | 3.2-4.4 | 1 | 167 | 0.9 | 61 |
| (ref) | double | 7.5-8.1 | 4 | 165 | 14.3 | 69 |
| Comp-4 | single | 3.8-3.9 | 2 | — | 1.4 | 59 |
| | double | 7.4-8.2 | 8 | 148 | 13.7 | 67 |
| Comp-5 | single | 3.3-4.7 | 3 | — | 1.1 | 62 |
| | double | 7.3-8.8 | 10 | 162 | >24 | 74 |
| Comp-6 | single | 3.1-3.2 | 2 | 146 | 0.1 | 63 |
| | double | 7.2-7.4 | 6 | 131 | >24 | 72 |
| Comp-7 | single | 3.2-3.6 | <1 | 147 | 0.1 | 67 |
| | double | 7.5-8.1 | 5 | 145 | >24 | 72 |

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. An aqueous composition for providing at least one barrier property, such as grease, oil and/or water barrier property, for a product comprising cellulosic fibres, the composition comprising α-(1,3→glucan) polymer and at least 0.1 weight-% of alkyl ketene dimer, calculated from dry solids weight of the composition.

2. The aqueous composition according to claim 1, wherein the composition comprises 0.1-40 weight-%, preferably 10-35 weight-%, more preferably 15-30 weight-%, of alkyl ketene dimer, calculated from dry solids weight of the composition.

3. The aqueous composition according to claim 1, wherein α-(1,3→glucan) polymer and alkyl ketene dimer are cationic.

4. The aqueous composition according to claim 1, wherein α-(1,3→glucan) polymer and alkyl ketene dimer are anionic.

5. The aqueous composition according to any of preceding claim 1, wherein α-(1,3→glucan) polymer has a substitution degree in a range of 0.05-3, preferably 0.1-2.0, more preferably 0.2-1.5, even more preferably 0.2-1.

6. The aqueous composition according to any of preceding claim 1, wherein α-(1,3→glucan) polymer has a degree of polymerization in a range of 55-10 000, preferably 55-5000, more preferably 100-1000.

7. The aqueous composition according to claim 1, wherein the alkyl ketene dimer is C14-C22 alkyl ketene dimer, preferably C16-C18 alkyl ketene dimer, or their mixture, preferably in form of polysaccharide stabilized aqueous dispersion.

8. The aqueous composition according to claim 1, wherein the alkyl ketene dimer has a charge density in the range from −100 μm/g to +600 μmeq/g, at pH 3.5.

9. The aqueous composition according to claim 1, wherein the composition has a solids content in a range of 2.5-50 weight-%, preferably 5-35 weight-%, more preferably 10-25 weight-%, and/or a viscosity in a range of 50-2000 mPas, preferably 50-1000 mPas.

10. (canceled)

11. The method according to claim 15, wherein the aqueous composition is applied by spraying on the surface of the product, which is preferably a three-dimensional product comprising cellulosic fibres.

12. The method according to claim 15, wherein the product is a moulded fibre product, such as a bowl, container, tray, plate or the like.

13. The method according to claim 15, wherein the aqueous composition is applied as two or more layers on the surface of the product.

14. The method according to claim 15, wherein the aqueous composition is added in a total amount of at least 1.5 g/m², preferably 1.5-15 g/m², more preferably 2-10 g/m².

15. A method for providing at least one barrier property, such as grease, oil and/or water barrier property, for a cellulosic product comprising cellulosic fibres, the method comprising:
forming the cellulosic product,
drying the cellulosic product,
applying an aqueous composition according to claim 1 on at least one surface of the product.
